(19) United States
(12) Patent Application Publication
(10) Pub. No.: US 2006/0262107 A1
(43) Pub. Date: Nov. 23, 2006

(54) System for operating display devices for image data via predetermined data bus configurations

(75) Inventors: Norbert Feuchtgruber, Diessen a. Ammersee (DE); Stefan Johann Warmuth, Mittelstetten (DE)

Correspondence Address: BEYER WEAVER & THOMAS, LLP, P.O. BOX 70250, OAKLAND, CA, 94612-0250, US

(73) Assignee: Data Display AG

(21) Appl. No.: 11/130,826

(22) Filed: May 17, 2005

(51) Int. Cl. G09G 5/00

(52) U.S. Cl. 345/204

(57) ABSTRACT

In a method and an apparatus for operating a display device, the display of which is generated and continuously renewed by successively received frames of image data which define one or several pixels, the image data for a frame is provided by a host computer via a serial bus. The data extracted from the data received via the serial bus are extracted at an electronic assembly connected between the host computer and the display device. The image data extracted is stored in an image memory of the electronic assembly and is displayed while controlling the electronic assembly. These steps are repeated for each of the frames.

### BACKGROUND OF THE INVENTION

1. Field of the Invention

The present invention relates to a system for operating display devices for image data via predetermined data bus configurations. In particular, the present invention relates to a method and an apparatus for providing image data to a display device, and to a method and an apparatus for providing image data for transmission to a display device in accordance with a predetermined data bus configuration.

2. Description of Prior Art

Common signal processing systems, such as PCs (personal computers), PDAs (personal digital assistants), computers, manufacturing controls and medical equipment, accomplish the control of display devices for image data by means of a graphics processor, which, in turn, is controlled via an operating system and the matching driver. The connection of a TFT LCD screen (TFT=thin film transistor, LCD=liquid crystal display) is performed via a graphics processor. The graphics processor, in turn, is connected via the internal busses, such as the PCI bus, which are common in the signal processing system. Mostly, the graphics processors are located on graphics boards. However, there are also signal processing systems wherein the graphics processor is integrated differently. Especially TFT LCD screens place particular requirements on the graphic cards and/or graphics processors with regard to the connections/terminals. To operate TFT LCD screens in signal processing systems, the user is required to open the signal-processing systems and, if possible, to equip them with suitable graphics processors. Even though there are technical possibilities of leading the busses to the outside, the technical principle remains the same, and thus technical expenditure remains relatively high.

For operating peripheral devices, such as printers, modems etc., signal processing systems have bus connections which are easy to handle, such as USB, RS232, parallel-port, Ethernet and V.24 bus connections.

The prior art has known approaches to controlling TFT LCD screens via the RS232 interface or the Ethernet interface of a computer. Here, however, “intelligent” control circuits need to be connected between the computer and the TFT LCD screen or be contained in the TFT LCD screen, since no image data in the form of pixels, but so-called image description data in the form of selected control commands are received via the interfaces mentioned above. The control circuit must decode these control demands and must further comprise suitable circuits to generate, on the basis of these control commands, the necessary image data in the form of pixels for display on the TFT LCD screen. The control circuit includes, e.g., a character generator which, on the basis of the control commands received, generates a character to be displayed and displays it on the TFT LCD screen. With these systems, the control signals transmitted via the RS232 bus are only those which then will be converted into images (circle, lines, rectangles, etc.) using a predefined graphics functionality. Therefore, the graphics functionality is highly limited. These systems are not very well suited to transmit and represent true images (e.g. photos) sent by a computer.

The approach just described is disadvantageous since only such control signals are transmitted from a host computer which are first converted into image data by the display controller, so that a certain computing power must be presumed which may be provided with difficulty only by low-cost MCUs (micro controller units), for example.

A simple possibility of operating a TFT LCD screen via the above-mentioned interfaces, so that image data is transmitted to same, does not exist. If TFT LCD screens are to be operated with the computer mentioned via one of the interfaces mentioned, said computer must be connected to a second computer via the interface in question, the TFT LCD screen then being connected to this second computer in a conventional manner (graphics board). This solution is not advantageous due to the very expenditure that would be associated with its implementation.

### SUMMARY OF THE INVENTION

Therefore, it is the object of the present invention to provide a simplified method and a simplified apparatus for operating display devices for image data via predetermined data bus configurations.

In accordance with a first aspect, the present invention provides a method for operating a display device, the display of which is generated by successively received frames of image data and is continuously renewed, the image data defining one or several pixels, the method including the steps of:
(a) providing the image data for a frame by a host computer via a serial bus;
(b) extracting the image data from the data received via the serial bus at an electronic assembly connected between the host computer and the display device;
(c) storing the extracted image data in an image memory of the electronic assembly, and displaying the image data stored under the control of the electronic assembly; and
(d) repeating steps (a) to (c) for each of the frames.

In accordance with a second aspect, the present invention provides an apparatus for operating a display device, the display of which is generated by successively received frames of image data and is continuously renewed, the image data defining one or several pixels, the apparatus having:

a serial interface for receiving the image data for a frame from the host computer via a serial bus;

an electronic assembly connected between the host computer and the display device and configured to extract, for each frame, the image data from the data received via the serial bus, to store the extracted image data in an image memory of the electronic assembly, and to display the image data stored under the control of the electronic assembly.

Thus, in accordance with the invention, provision has been made for a simple possibility of operating display devices for image data, such as TFT LCD screens, via a standardized peripheral connection bus, such as the USB, RS232, parallel-port, Ethernet or V.24 bus connection. The use of separate graphics processors on graphics boards, which is otherwise associated with a large amount of technical expenditure, and the associated opening of the system, are dispensed with. The systems generate the image data and do not pass it on to a graphics processor or a graphics board, but output this image data directly via the interface, so that this data may be displayed, on reception at the display device, without any further conversion.

In accordance with a preferred embodiment, the display device includes a touch screen operated via the same interface via which the image data is received.

An advantage of the present invention is that the performance required of the processing means (MCU) provided is only little, since the only thing that needs to be done is to supervise data transport and to pass on the pixel data to the screen in a 1:1 fashion. The image is generated in the host computer and transferred to the display control as a finished image. No further “interpreting” of the data received is required.

### BRIEF DESCRIPTION OF THE DRAWINGS

Preferred embodiments of the present invention will be explained below in more detail with reference to the accompanying figures, wherein:

FIG. 1 shows a block diagram of the inventive system for operating a display device via an interface of a predetermined data bus configuration in accordance with a preferred embodiment;

FIG. 2 shows a block diagram of the electronic assembly, shown in FIG. 1, with a screen connected;

FIG. 3 shows a detailed block diagram of the electronic assembly shown in FIG. 2 in accordance with a preferred embodiment;

FIG. 4 shows the steps performed in the MCU of FIG. 3 in data transmission;

FIG. 5 shows the steps performed in the PLD of FIG. 3 for generating an address signal from the counts of a horizontal counter and a vertical counter;

FIG. 6 shows the steps performed in the PLD of FIG. 3 for controlling the display device;

FIG. 7 shows the steps performed in the PLD of FIG. 3 for complete transmission of an image to the image memory;

FIG. 8 shows the steps performed in the PLD of FIG. 3 for ascertaining whether a change of picture is taking place on the display device;

FIG. 9 shows a block diagram of the computer, shown in FIG. 1, with an display system connected for illustrating the exchange of information between an application which generates the image data, a control means for the display device, a means which executes the data transfer, and a means for controlling the display device;

FIG. 10 shows a communication process between the application of FIG. 9 and a driver; and

FIG. 11 shows a sequence of the procedure of a data transfer to a USB system.

### DESCRIPTION OF PREFERRED EMBODIMENTS

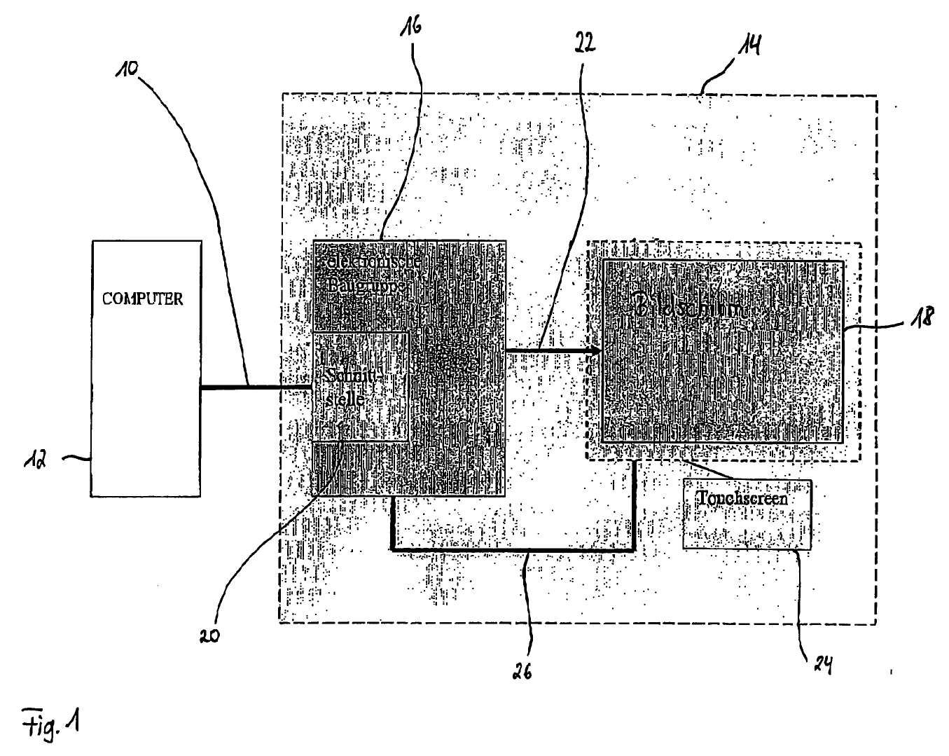

With reference to FIG. 1, a block diagram of the inventive system for operating a display device via an interface of a predetermined data bus configuration in accordance with a preferred embodiment will be described in more detail. In the below description of the preferred embodiments, elements which are identical or act in the same manner will be given the same reference numerals.

The system shown in FIG. 1 includes a data bus 10, which connects a computer 12, a PC, a PDA, a manufacturing control, medical equipment, or a different computer system, to a display means 14 which includes an electronic assembly 16 and a display device and/or a screen 18, e.g. TFT LCD screen. The electronic assembly 16 further includes an interface 20 and generates a indicating signal for screen 18 from the signals/data received at interface 20. The indicating signal is transmitted, via a connection 22, from the electronic assembly 16 to screen 18.

Optionally, screen 18 may have a touch screen 24 associated with it which is connected to the electronic assembly 16 via a connection 26 so as to pass on information concerning a touched point on screen 18 to the electronic assembly 16 and from there, via interface 20, to computer 12 so as to initiate the adequate steps there.

The image data to be displayed on screen 18 are provided by computer 12 in the form of pixels, preferably in the form of bitmaps, are subsequently converted into a format corresponding to interface 20 which corresponds to a predetermined data bus configuration, and are provided at an interface (not shown in FIG. 1) of computer 12 for transmission to display system 14. This data is transmitted to interface 20 via data bus 10, which supports the predetermined data bus configuration. The data received at interface 20 are processed in the electronic assembly 16 for generating the indicating signal. Electronic assembly 16 extracts the image data from the corresponding data bus format and generates the indicating signal for screen 18, which is transmitted to the screen via connection 22.

The data bus format for transmitting the image data, and the configuration of the interfaces of computer 12 and of display system 14 correspond, in accordance with the preferred embodiment, to the USB, the RS232 or the parallel-port data bus format. It is also possible to use other known interface and/or data bus configurations, such as the Ethernet standard, the V.24 standard, etc.

A typical application of the present invention is the use of machines, e.g. selling machines for small goods. Typically, modern selling machines will comprise screens or displays for user guidance. The present invention is particularly suited for small displays having a resolution of, e.g., 320×240 picture elements, also referred to as QVGA. In accordance with the invention, when using the USB 2.0 bus, an image may be renewed, for transmission, about 50 times per second, which is adequate for the above-mentioned application. In other applications, it is also possible to use several displays and/or screens in parallel with conventional screens.

The present invention will be explained below in detail by means of the example of the USB interface.

A graphics bitmap is transmitted via the USB interface 20 on the part of the host system 12 (e.g. a PC). In the solution depicted here, a format of 320×240 picture elements (pixels) with a color depth of 16 bits is used. Of course, the present invention is not limited thereto, and other formats may also be used. The graphics bitmap thus is a binary data format of 320×240×16 bits.

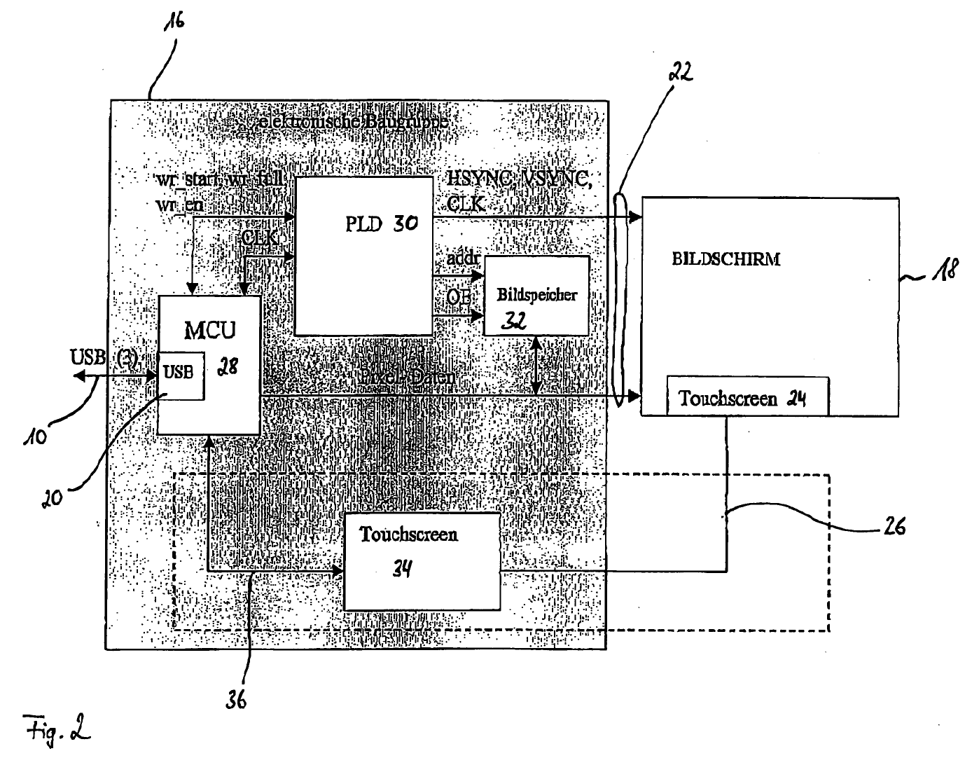

A preferred embodiment of electronic assembly 16 and the associated software will be explained below with reference to FIGS. 2 to 8. A preferred embodiment of the necessary configuration of computer 12 will be explained with reference to FIGS. 9 to 11.

FIG. 2 shows a block diagram of the electronic assembly 16 shown in FIG. 1 with screen 18 connected thereto. The electronic assembly 16 includes a control 28 (MCU) which includes USB interface 20. In addition, electronic assembly 16 includes a timing means 30 (PLD=programmable logic device), an image memory 32, preferably a RAM memory (RAM=random access memory), and an optional touch-screen control 34 which is provided when the screen 18 has touch screen 24 associated with it, as in the example shown. As may be seen in FIG. 2, the individual components of electronic assembly 16 are interconnected for data exchange via a plurality of lines. To put it more precisely, MCU 28 and PLD 30 exchange signals WR_START, WR_FULL and WR_EN via one line, respectively, and exchange the clock signal CLK via another line. In addition, MCU 28 is connected to the image memory 32 and the screen 18 via a data bus carrying the pixel data. PLD 30 provides image memory 32 with signals OE and addr, and provides screen 18 with signal HSYNC and VSYNC as well as with clock signal CLK. Touch-screen control 34 is connected to touch screen 24 via connection 26, and exchanges the information required for operating touch screen 24 with MCU 28 via connection 36.

As may be seen, signals HSYNC, VSYNC, CLK as well as the pixel data is transmitted via the common connection 22.

Electronic assembly 16 essentially consists of two parts, MCU 28 (micro controller unit) and timing means 30 (timing engine) which here is preferably implemented by the PLD.

MCU 28 is mainly responsible for data transport from computer 12 (host) to electronic assembly 16. PLD 30 mainly generates the synchronizing signals HSYNC (horizontal synchronization), VSYNC (vertical synchronization) for screen 18, and address signals addr for image memory 32.

MCU 28 is equipped with USB interface 20, via which the graphics bitmap data to be displayed are transmitted from computer 12 to electronic assembly 16. Subsequently, the data is passed on/routed to image memory 32.

Since screen 18, image memory 32 and MCU 28 share a common data bus (“pixel data” data bus in FIG. 2), access to these elements must be controlled. To this end, the output of image memory 32 is enabled within the period of the falling edge of clock signal CLK, and the output of MCU 28 is enabled within the period of the rising edge of clock signal CLK. The setup and hold times, which are due to technological reasons, are taken into account.

The optional touch-screen control 34 is commercially available and is operated via serial bus 36 at MCU 28. As will be explained in more detail below, a program memory for the MCU firmware is also connected to this bus. The touch screen data is transmitted to computer 12 by means of a USB interrupt transfer.

Brightness control of screen 18 is accomplished by means of the PWM method (PWM=pulse width modulation). For this purpose, two “auto reload timers” integrated into MCU 28 are used. Via PLD 30, one timer is enabled for the “high phase” (high logic level), and the other timer is enabled for the “low phase” (low logic level) of the PWM signal, respectively, in an alternating fashion. With the signals which are generated by the timers at the end of one interval, PLD 30 toggles the PWM signal, as will be explained below in more detail.

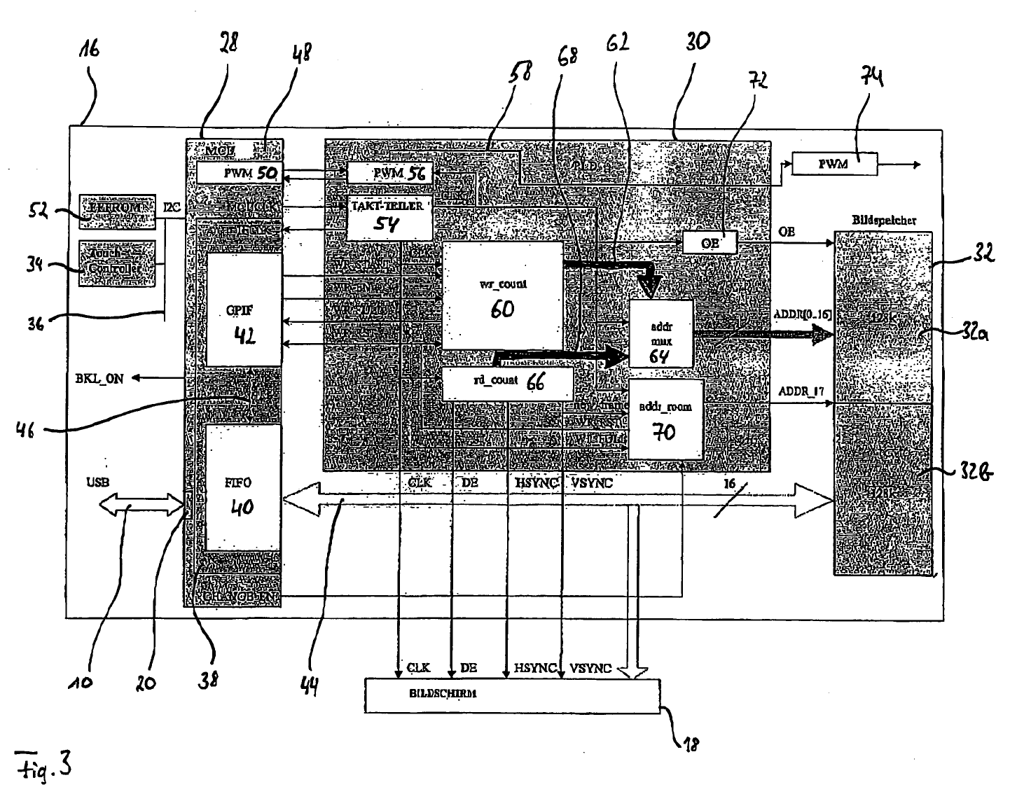

With reference to FIG. 3, a detailed block diagram of a preferred embodiment of the electronic assembly shown in FIG. 2, and, in particular, of MCU 28, PLD 30 and image memory 32 will be described in more detail below.

In addition to the USB interface, MCU 28 includes a data transfer section 38 comprising a FIFO memory 40 (FIFO=first-in first-out) and a multi-purpose interface 42 (GPIF=general purpose interface). As can be seen, GPIF 42 outputs signals WR_START and WR_EN to PLD 30, receives signal WR_FULL from same and exchanges signal WR_RST with same. Via the 16 bits data bus 44, FIFO memory 40 is connected to image memory 42 and screen 18 for transmitting the pixel data. FIFO memory 40 and GPIF 42 are connected via a connection 46. The data transfer section 38 of MCU 28 also receives an interface clock IFCLK from PLD 30.

MCU 28 includes a further section 48 wherein the CPU (not shown) of MCU 28 is arranged. In the further section 48, a timer/PWM circuit 50 is arranged which provides signals to PLD 30 and receives signals from same. In addition, the MCU clock MCUCLK is provided to PLD 28, as well as signal CHANGE_EN. In addition, signal BKL_ON is generated and output. Signal BLK_ON switches on or off the background illumination of the TFT LCD screen, which is controlled via a USB VENDOR CALL. From the application side, this USB VENDOR CALL is trigged via the driver-side function IOCTL( ). Via the serial bus 36, MCU 28 is connected to touch-screen control 34 and a memory 52 (preferably an EEPROM) wherein the MCU firmware is stored.

PLD 30 includes a clock divider 54 which receives the MCU clock MCUCLK from MCU 28 and outputs the interface clock IFCLK to the data transfer section 38 of MCU 28. In addition, clock divider 54 outputs clock signal CLK.

A PWM circuit 56 is provided which receives clock signal CLK, and provides signals to timer/PWM circuit 50 of MCU 28 and receives signals from same. In addition, PWM circuit 56 provides a control signal on line 58.

A first counter 60 (wr_count) receives signals WR_START and WR_EN from MCU 28. It outputs signal WR_FULL to MCU 28. In addition, the first counter 60 exchanges signal WR_RST with MCU 28. From clock divider 54, first counter 60 receives clock signal CLK. Via a first bus 62, first counter 60 outputs its count to an address multiplexer 64 (addrmux), which further receives a count of a second counter 66 via a second bus 68. Via a 17 bits bus, the address multiplexer 64 outputs address signal ADDR[0 . . . 16] to image memory 32. In addition, address multiplexer 64 receives clock signal CLK from clock divider 54.

The second counter 66 receives clock signal CLK from clock divider 54 and outputs, in addition to the count, signals DE, HSYNC and VSYNC to screen 18. In addition, signal VSYNC is applied as signal new_frame to an address-space selection circuit 70, which further receives signal WR_FULL and transmits signal WR_RST. Address-space selection circuit 70 outputs a selection signal ADDR_17 to image memory 32, and further receives clock signal CLK from clock divider 54.

In addition, PLD 30 includes circuit 72 (OE) for generating an enable signal OE for image memory 32, depending on the clock signal CLK received.

Electronic assembly 16 further includes PWM circuit 74 controlled by PWM circuit 56 of PLD 30 via line 58 so as to generate a brightness signal.

Image memory 32 has two memory sections 32a and 32b, which alternately receive pixel data from MCU 28 and output same to screen 18.

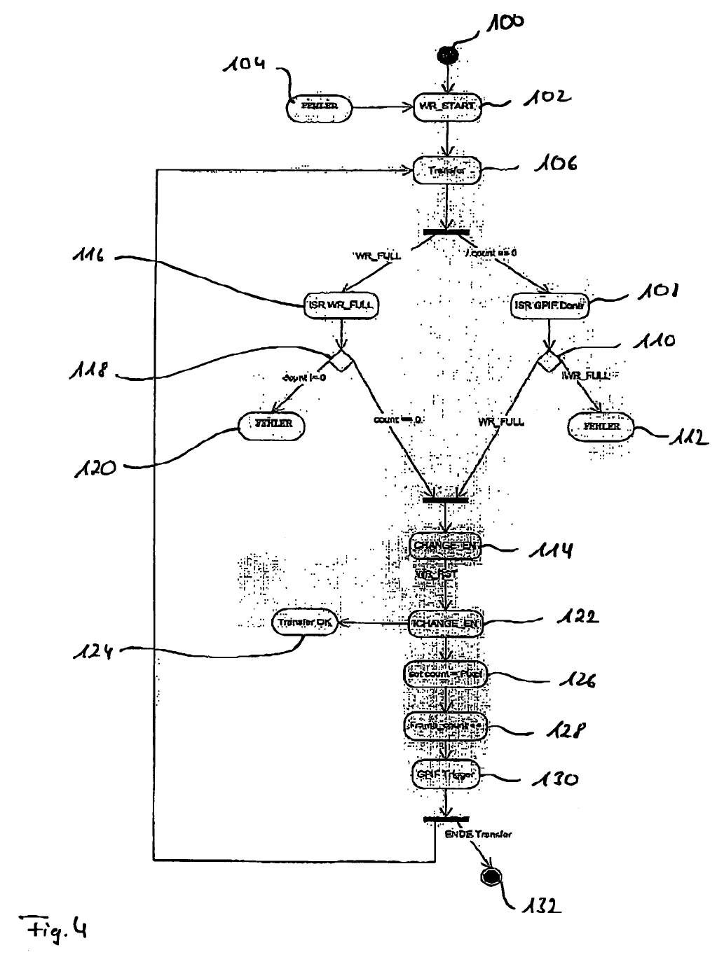

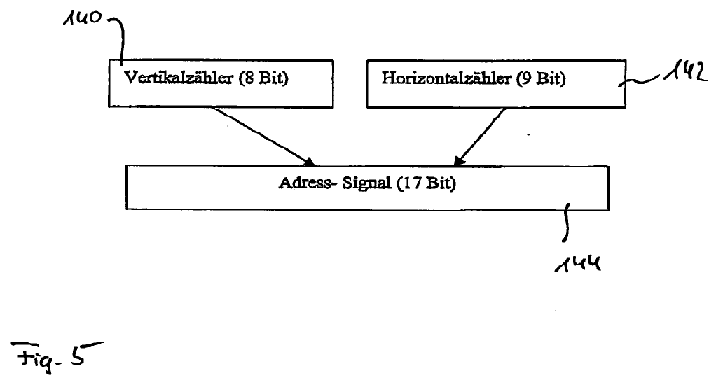

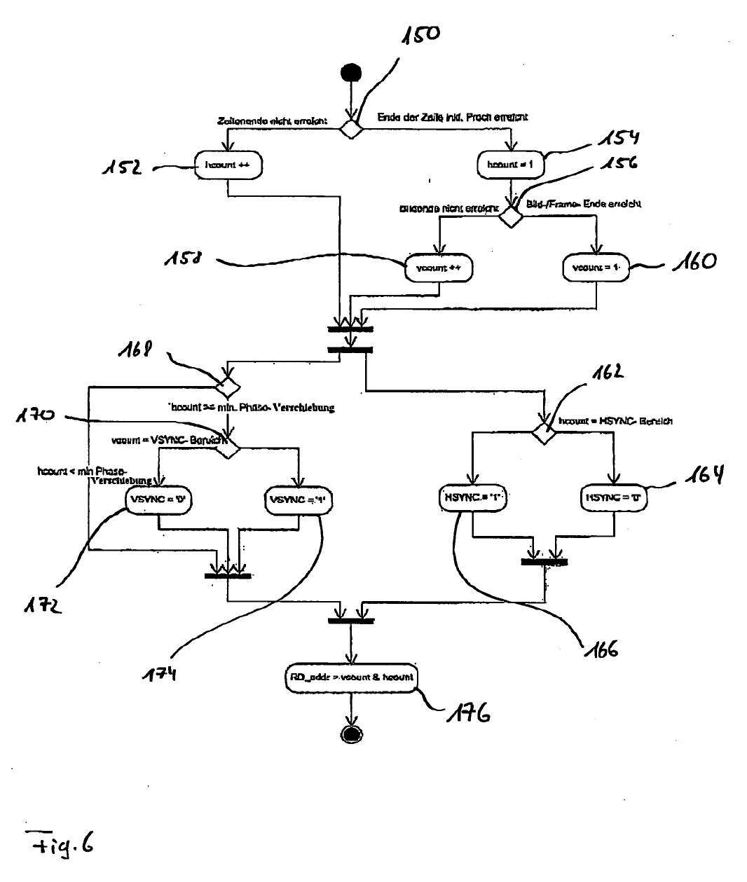

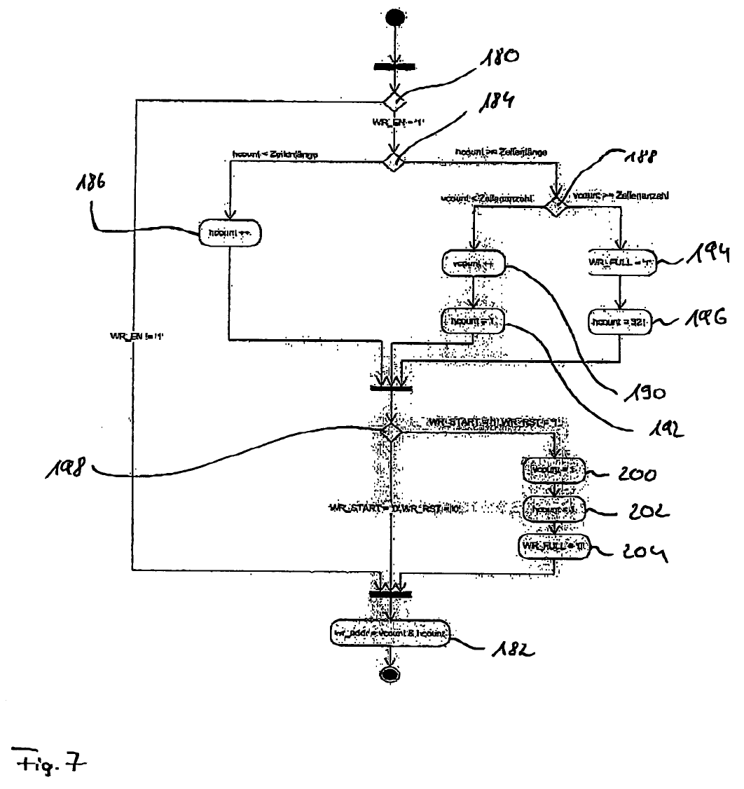

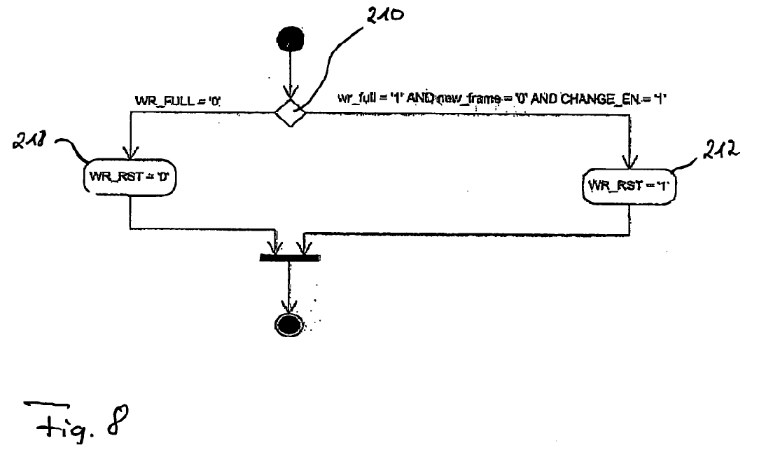

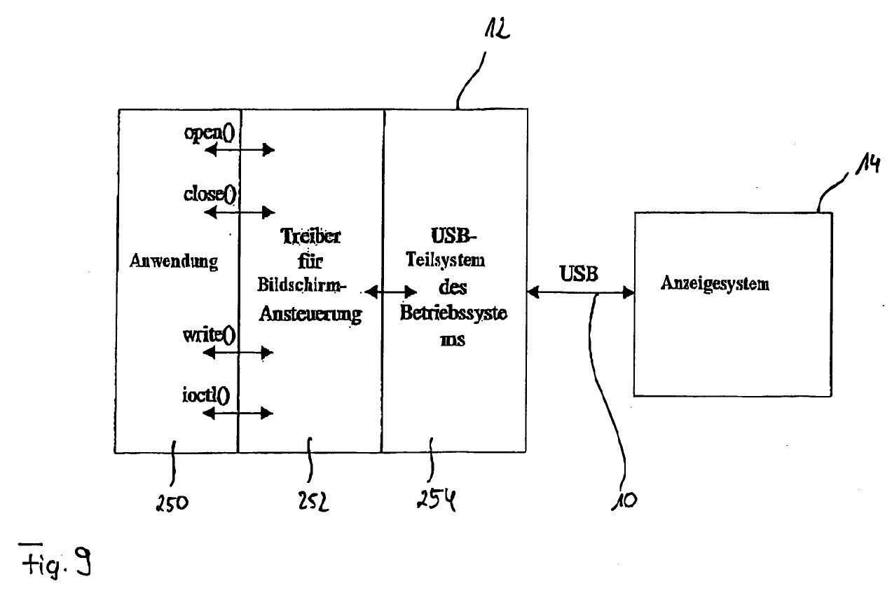

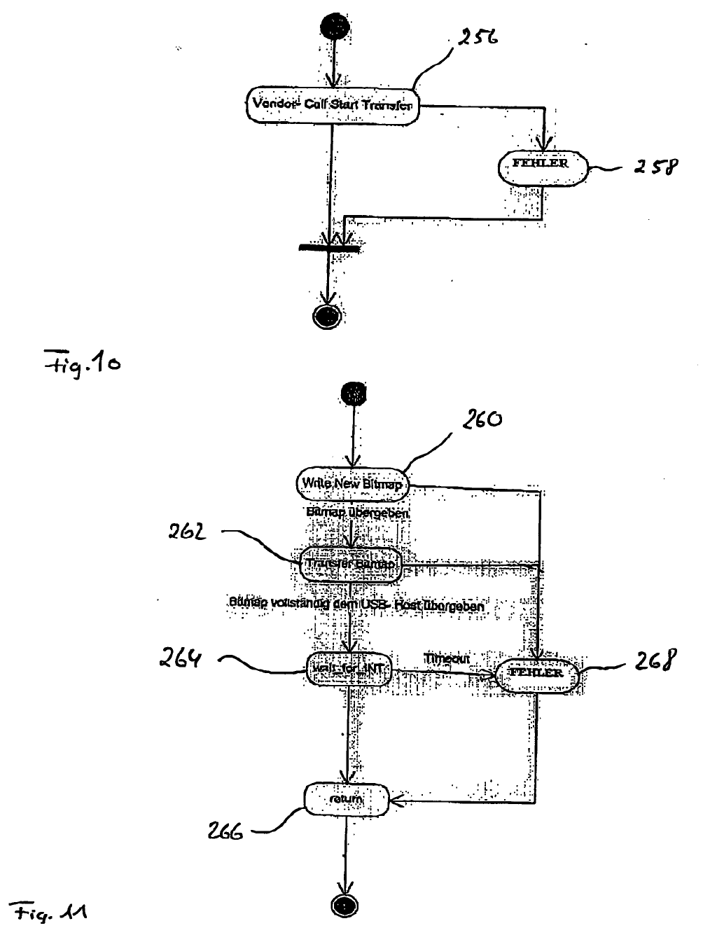

With reference to FIGS. 3 and 4, the functionality of MCU 28 will be explained below in more detail. MCU 28 regulates transfer of the graphics bitmap data from host 12 into image memory 32. The actual data transfer is accomplished by the GPIF unit 42 integrated into MCU 28 in a manner substantially independent of the integrated CPU. GPIF unit 42 is a state machine which controls a DMA data transfer from the FIFO memory 40, which is also integrated in MCU 28, into image memory 32. For this purpose, GPIF 42 comprises a counter which is filled with the number of data to be transmitted, i.e. the number of pixels of a complete bitmap. The counter is set to “WR_START” by a USB vendor call. In addition, GPIF 42 is initialized. The call WR_START also sets signal WR_START in order to set the address counter 60 in PLD 30 to the memory start position/address of an image.

The bitmap data coming in from USB bus 10 are stored in FIFO memory 40. This is accomplished, automatically, by a SIE unit (SIE=USB serial interface engine) integrated into MCU 28. GPIF 42 recognizes that data is available in FIFO memory 40, and autonomously transmits same to image memory 32.

Addressing the memory is performed by PLD 30. If GPIF 42 applies valid pixel data to data bus 44, this is indicated by signal WR_EN. The data is taken over with the rising edge of clock signal CLK in image memory 32. For each pixel transmitted, the counter of GPIF 42 is decremented. Once a complete image has been transmitted, an interrupt is triggered in MCU 28 by signal WR_FULL from PLD 30. The ISR (interrupt service routine) which is consequently started in MCU 28 verifies the counter reading of GPIF 42. If it is “ZERO”, this indicates successful transfer. Thus, a complete new image has been stored in image memory 32. This is indicated by means of signal CHANGE_EN by MCU 28. As a consequence, address-space selection circuit 70 of PLD 30 changes the address space at the earliest possible point in time, i.e. at the time of the vertical blanking interval, and the new image is displayed. If PLD 30 changes the address space, it resets the first counter 60 and thus signal WR_FULL. This is indicated by signal WR_RST and, in turn, triggers an interrupt in MCU 28. ISR, which is started as a consequence, again resets signal CHANGE_EN, sets the counter of GPIF 42 back to the pixel number of a complete image and starts GPIF 42 for renewed data transfer. In addition, host 12 is informed about the successful data transfer via a USB interrupt transfer.

If signal WR_FULL is indicated, and if the ISR thus triggered recognizes that the counter of GPIF 42 is not “ZERO”, the behavior at hand is abnormal. This is communicated to host 12 by a USB interrupt transfer. Then the host must reset the system via USB vendor call “WR_START”, and must restart data transfer.

Further abnormal behavior is at hand if the counter of GPIF 42 runs on “ZERO”, but signal WR_FULL is not set by PLD 30. If the GPIF then runs on “ZERO”, an interrupt is triggered in MCU 28. This interrupt has a lower priority than the interrupt by signal WR_FULL. This is why interrupt “GPIF counter ZERO” is normally masked out by “ISR WR_FULL” and thus does not trigger the ISR “GPIF counter ZERO”. In the event of abnormal behavior, however, ISR “GPIF counter ZERO” is enabled, since no signal WR_FULL is applied to indicate the abnormal behavior. This is communicated to host 12 by a USB interrupt transfer. Host 12 must then reset the system via the USB vendor call WR_START and restart the data transfer.

By means of the flow chart depicted in FIG. 4, the functionality just described is illustrated once more. The sequence starts at 100 due to a USB vendor call and then proceeds to block 102 (WR_START). Alternatively, the sequence returns to block 102 from an error-handling routine, as is indicated at block 104. In block 102, the signal WR_START is set. Thus, address counter 60 in PLD 30 is reset, and the counter of GPIF 42 is set to the number of pixels to be transmitted (here 320×240 pixels).

The sequence then proceeds to block 106 (TRANSFER), which effects transmission of the image data. GPIF 42 transmits the image data autonomously, and with each pixel transmitted (here 16 bits), the counter of GPIF 42 is decremented.

During data transmission, signal WR_FULL and the “count” of the GPIF counter are monitored. In block 108, the interrupt service routine “ISR GPIF DONE” is called by GPIF 42. The GPIF transmits the image data until the data counter “count” runs on zero. This triggers interrupt 4. In block 110, signal WR_FULL is used to verify whether the image memory is completely filled once all pixels have been transmitted. If this is not so, the sequence proceeds to error block 112 which indicates an error in transmission, resets GPIF 42 and PLD 30 and indicates the error to host 12 via the interrupt transfer. If it is indicated that image memory 32 is completely filled once all pixels have been transmitted, the sequence proceeds to block 114 (CHANGE_EN).

If the address counter 60 of PLD 30 overflows, this is indicated by signal WR_FULL, and at block 116, interrupt 1 is triggered. In addition, interrupt 4 must be masked and reset, since normally it is triggered immediately afterwards. Since signal WR_FULL is in a state which indicates that the image memory is filled, a verification is subsequently made at block 118 as to whether the necessary number of pixels have been transmitted. If this is not so, the sequence proceeds to block 120, which indicates an error in transmission, resets GPIF 42 and PLD 30 and indicates the error to host 12 via the interrupt transfer. If it is indicated that all pixels have been transmitted (“count”=ZERO), the sequence precedes to block 114 (CHANGE_EN).

In block 114 (CHANGE_EN), signal CHANGE_EN is enabled to allow PLD 30 to change the memory area in image memory 32. Thus, the image transmitted is displayed, and the memory area of the preceding image is free for another transmission.

In block 122, the change of the memory area and thus of the image displayed is effected in the vertical blanking interval. The change is indicated by signal WR_RST. To this end, PLD 32 autonomously resets counter 60. Signal WR_RST triggers an interrupt which indicates, at block 124, that the transfer was according to the rules, the successful data transfer of a bitmap further being indicated to host 12 at block 124 via an interrupt transfer. Subsequently, signal CHANGE_EN is reset again in block 122.

Subsequently it is found, in block 126, that a free memory location is available for transmission. The counter of GPIF 42 is again set to the number of pixels of one image (here 320×249 pixels)

In block 128, a frame counter is incremented. The counter reading of this frame counter may be queried at any time by host 12 via a vendor call. Thus, the host may determine, via USB connection 16, which images (frames) have been transmitted and displayed, and which ones have not.

Subsequently, a new transmission of image data with GPIF 42 is started at block 130, and the sequence returns to block 106 or ends at 132 if there is an end transfer instruction which was communicated by a USB vendor call.

With reference to FIGS. 3 and 5 to 8, the functionality of PLD 30 will be explained in more detail below. PLD 30 generates the synchronizing signals HSYNC and VSYNC necessary for screen 18, and generates the addresses for image memory access. Clock signal CLK is generated from clock signal MCUCLK of MCU 28 by frequency division. Also, PLD 30 controls signal OE (output enable) for image memory 32. The output of the image memory 32 is enabled such that screen 18 may take on the pixel data on the falling edge of clock signal CLK from image memory 32.

The two counter units 60 and 66 are implemented. The first unit 60 is responsible for data transport from MCU 28 to image memory 32. The other unit 66 is responsible for controlling screen 18. From the counts, the address signal for the image memory 32 is generated in each case. For this purpose, the counter units 60 and 66 consist of two counters each, of the horizontal counter and the vertical counter, respectively. The horizontal counter is incremented with clock signal CLK. The value of the counter thus corresponds to the position of a pixel within a line. The vertical counter is incremented by the overflow of the horizontal counter, i.e. at line frequency. Thus, the value of the vertical counter corresponds to the line position. Together, the horizontal counter and the vertical counter yield a memory address corresponding to the pixel position. As is shown in FIG. 5 at 140, the vertical counter includes an 8 bits count. The horizontal counter includes, as is shown at 142, a 9 bits count. Linking the counts in a suitable manner yields the 17 bits address signal as is shown at 144.

By the subdivision into the vertical counter and the horizontal counter, the synchronizing signals may also be generated. Counter unit 66 for controlling the screen generates signals HSYNC and VSYNC. Comparators monitor the counter readings and set and/or reset the synchronizing signals at the corresponding positions in accordance with the specification of TFT screen 18.

FIG. 6 illustrates the generation of the synchronizing signals. With each rising edge of clock signal CLK, a determination is made, at block 150, as to whether or not the end of a line has been reached. If the end of the line has not been reached yet, the horizontal counter (“hcount”) is incremented in block 152. If the end of the line has been reached, the horizontal counter is set to a value of 1 in block 154. Once the horizontal counter has been set to the value of 1 in block 154, a verification is made, in block 156, as to whether or not the end of the image has been reached. If the end of the image has not been reached yet, the vertical counter (“vcount”) is incremented in block 158. If the end of the image and/or the end of the frame has been reached, the vertical counter is set to a value of 1 in block 160. Subsequently, the synchronization of the screen is controlled on the basis of the counts thus set.

On the basis of a specification for the SYNCH signals of the screen, a verification is made, in block 162, as to whether or not the value of the horizontal counter (“hcount”) corresponds to a predefined HSYNC range. If this is so, HSYNC is set to a value of 0 in block 164. If this is not so, HSYNC is set to a value of 1 in block 166.

On the basis of a specification for the HSYNC/SYNCH phase shift of the screen a verification is made, in block 168, as to whether the value of the horizontal counter falls below a minimum phase shift value. If the value of the horizontal counters falls below the minimum phase shift value, no further action is performed. If the value of the horizontal counter reaches the minimum phase shift value or exceeds same, a verification is made, in block 170, on the basis of a specification for the SYNCH signals of the screen, as to whether the value of the vertical counter (“vcount”) corresponds to a predefined VSYNC range. If this is so, VSYNC is set to a value of 0 in block 172. If this is not so, VSYNC is set to a value of 1 in block 174.

Eventually, memory address RD_ADDR is determined from counts “vcount” and “hcount” in block 176.

Counter unit 60, which is responsible for transporting the image data from MCU 28 into image memory 24, indicates, by means of signal WR_FULL, complete transmission of an image into image memory 32, as is illustrated by FIG. 7.

On each rising edge of clock signal CLK, a verification may, in block 180, on the basis of signal WR_EN, as to whether data has been written into the memory and/or whether MCU 28 provides valid data.

If there is no data to be written. (WR_EN different from 1), the memory address is not changed in block 182, since counts “vcount” and “hcount” are not changed.

If there is data to be written into the memory, a verification is made, in block 184, as to whether the line end has been reached (value “hcount” is higher than or equals the length of the line) or not (value “hcount” is smaller than the length of the line). If the end of the line has not been reached yet, the value of the horizontal counter is incremented in block 186. Otherwise, a verification is made, in block 188, as to whether the end of the image has been reached (the value of the vertical counter “vcount” is higher than or equals the number of lines) or not (the value of the vertical counter “vcount” is smaller than the number of lines). If the end of the image has not been reached yet, the vertical counter is incremented in block 190, and the horizontal counter is set to a value of 1 in block 192, which means that the number of lines is increased and the pixel number has been reset to the beginning of the line.

Once the end of the image is reached, signal WR_FULL is set to a value of 1 in block 194, and the value of the horizontal counter is set to an unused memory address in block 196. In this manner, an indication is given that the complete image is contained in the memory.

Subsequently, signals WR_START and WR_RST are verified in block 198. If they are not enabled (here: lower logic level), i.e. no new data transmission has started, no further changes are made to the counts, and at 182, the memory address is formed. Otherwise, i.e. if signals WR_START and WR_RST indicate that a new data transmission is started (new image), the value of the vertical counter is set to a value of 1 in block 200, the value of the horizontal counter is set to the value of 1 in block 202, and signal WR_FULL is disabled in block 204 so as to set the two counters to the beginning of the image and to reset signal WR_FULL. Subsequently, the memory address is formed in block 182.

In order to avoid so-called frame tears, the “double buffer” principle is employed. For this purpose, image memory 32 is subdivided into the two areas 32a and 32b, which may encompass a complete image, respectively. The most significant address bit of image memory 32 is used to subdivide same into the upper and lower memory areas 32a, 32b. One area serves to provide screen 18 with the image data, and the other receives the new image data coming in from MCU 28. Switching is constantly performed, in an alternating manner, between areas 32a and 32b. On the rising clock edge, that area which receives the new data from MCU 28 is active, and on the falling edge, the active area is that containing the image data to be displayed. If a new image has been fully transmitted, the areas are exchanged. The address-space unit 70 is responsible for this. Via signal WR_FULL, address-space unit 70 recognizes that a new image is contained in memory 32. By signal new_frame, which corresponds to the VSYNC signal, address-space unit 70 recognizes the vertical blanking interval. At this point in time, an image change may be performed. By means of signal CHANGE_EN, MCU 28 gives permission for a change of image. If both signals WR_FULL and new_frame are indicated and if the signal CHANGE_EN has been set, the memory area is exchanged, and thus a new image is output on the screen. The change is indicated by signal WR_RST, the generation of which will be explained in more detail with reference to FIG. 8.

With each rising edge of a clock, a determination is made in block 210 as to whether or not a change in the address spaces is indicated by signals WR_FULL, new_frame and CHANGE_EN. If a change in the address spaces is to be performed, reset signal WR_RST is enabled in block 212 so as to reset counter 60 and to indicate the change of image to MCU 28. Otherwise, signal WR_RST is disabled in block 218.

In accordance with the address area which is active at the moment, the address signal of the counter unit for data transport and/or for controlling the screen is placed on the address lines of image memory 32, which is performed by the address multiplexer 64 (addrmux).

A block diagram of an embodiment of computer 12, shown in FIG. 1, with an display system 14 connected will be explained with reference to FIGS. 9 to 11. In this embodiment, an application 250 is provided which runs on the computer and generates image data. The application passes the image data to a driver 252 which cooperates with a USB subsystem 254 of the operating system.

On the host side 12, the transfer of graphics bitmap data is accomplished with the software driver 252. The latter provides the application programmer and/or the application 250 with the interfaces required for transferring the bitmaps, and provides success and/or error codes.

The steps for opening and closing the interface and for transmitting data will be explained in more detail with reference to FIG. 10. After initially opening the interface, a transmission from host 12 is started by the “USB vendor call” in block 256 so as to initialize the transfer. The call WR_START sets signal WR_START so as to set the address counter 60 (wr_count) in PLD 30 to the memory start position/address of an image. The call is performed when opening the driver interface via the call OPEN( ) (see FIG. 9). If the USB vendor call cannot be conducted in block 256, an error code which indicates unsuccessful opening of the USB vendor call is generated and returned in block 258. Otherwise, that is, if no error occurs, successful initialization is confirmed to application 250 by block 256 via a return value.

Now, graphics bitmaps may be transferred via function WRITE( ) of the driver. Only bitmaps having a suitable format, here 320×240×16 bits, can be transferred. Other formats are rejected and discarded by the driver with an error code in the return value. If other formats are to be used, the driver is to be modified accordingly. Provision may also be made for the driver 254 to support several formats and to initially establish the suitable format.

FIG. 11 illustrates the one sequence of the data transfer from computer 12 to display system 14. Bitmap data transmission is performed via a USB bulk transfer. In the bulk transfer, the USB bus does not take on data protection (see USB specification). This is why error-free data transport may be relied upon with regard to both the driver and firmware. If the USB host controller cannot deliver the data, an error code is returned. The errors occurring between MCU 28 and PLD 30 and which are recognized by the MCU firmware are conveyed by means of a USB interrupt transfer. If driver 252 recognizes an error, data transmission is interrupted, and an error code is returned. In the event of a correct transmission, driver 252 waits until MCU 28 confirms the display of the new bitmap by means of a USB interrupt transfer. If same is confirmed, the number of the bits transmitted of the writing application 250 is returned. Thus, application 250 recognizes error-free transmission. Then, a new image may be transmitted. In the event of an error, the driver interface must be closed and reopened by the application so as to reset the system. Alternatively, the system may also be reset via the IOCTL( ) function.

As can be seen in FIG. 11, a graphics bitmap is transferred to driver 252 after the write system call in block 260. Subsequently, the bitmap is transmitted in block 262. Once the bitmap has been completely transferred to the USB host, the process waits, in block 262, until successful transmission is indicated via an interrupt transfer. In block 266, successful transmission is indicated by returning the number of bytes transmitted, i.e. by returning a complete bitmap (in the 16 bits system which is described by way of example in the present document, the number of lines of a bitmap). Subsequently, the interface is closed.

If it is found in block 260, when transferring the bitmap, that the bitmap transferred does not have the correct size and/or the correct format, an error value is determined via block 268 and is returned at block 266. Even if an error occurs while transmitting the bitmap, an error is indicated by an interrupt transfer, transmission is interrupted, and an error value is determined via block 268 and is returned at block 266. The same applies if it has been found, in block 264, that an admissible waiting time has been exceeded.

Depending on the circumstances, the inventive method may be implemented in hardware or in software. Implementation may be performed on a digital storage medium, in particular a disc or CD with electronically readable control signals which may cooperate with a programmable computer system such that the respective method is performed. Generally, the present invention thus also consists in a computer program product with a program code, stored on a machine-readable carrier, for performing the inventive method when the computer program product runs on a computer. In other words, the invention may thus be realized as a computer program with a program code for performing the method when the program runs on a computer.

Even though a preferred embodiment of the present invention has been described above with reference to the USB format, the present invention is not limited thereto. Other interface formats, e.g. RS232, parallel-connection, Ethernet, etc. may also be used. Also, the image data may be transferred in bitmaps with a different resolution or in another form.

In the above-described embodiment, only pixel image data, preferably in the form of bitmaps, are transmitted via the interface. However, the present invention is not limited thereto. For example, in certain cases of application it may be desired to initially control addressing of the image memory 32 via the interface. In this case, a memory address will then be sent via the interface prior to the actual image data packet. Subsequently, the actual image data packet is sent, and the data contained therein is passed on into the image memory on the basis of the memory address obtained in advance.

As the above description shows, the inventive solution is advantageous since directly usable image data (pixels) are transmitted which may be displayed without any further conversion, which reduces the expenditure in terms of software and hardware.

In the description of the preferred embodiment, transmission of the image data without compression has been described. However, if the data volume is large, the image data may be compressed by means of suitable techniques prior to transmission via the serial bus. Extracting the data at the electronic assembly will then also include decompressing the data.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

What is claimed is:

1. A method for operating a display device, the display of which is generated by successively received frames of image data and is continuously renewed, the image data defining one or several pixels, the method comprising:
(a) providing the image data for a frame by a host computer via a serial bus;
(b) extracting the image data from the data received via the serial bus at an electronic assembly connected between the host computer and the display device;
(c) storing the extracted image data in an image memory of the electronic assembly, and displaying the image data stored under the control of the electronic assembly; and
(d) repeating steps (a) to (c) for each of the frames.

2. The method as claimed in claim 1, wherein step (c) includes collecting a predetermined quantity of image data in the image memory, the image data being displayed upon achieving the predetermined quantity.

3. The method as claimed in claim 2, wherein collecting the image data includes counting the extracted and latched image data.

4. The method as claimed in claim 1, wherein the display device has a first resolution in the horizontal direction and a second resolution in the vertical direction, the image memory comprising a plurality of line sections, the size of the line sections corresponding to the horizontal resolution of the display device, the number of the line sections corresponding to the vertical resolution of the display device, the method further comprising:
beginning with a first line section, writing the image data into the image memory until the first line section has been filled;
incrementing the line section to be written onto, and writing the image data into the further line section; and
repeating the steps of incrementing and writing until the number of line sections written onto corresponds to the vertical resolution of the display device.

5. The method as claimed in claim 4, wherein the image memory includes a first memory section and a second memory section, the first/second memory section receiving image data, while the second/first memory section provides image data for display.

6. The method as claimed in claim 1, wherein the display device has a touch screen associated therewith, the method further comprising:
receiving information about the coordinates of a point located on the display device which has been touched;
converting the information received in the electronic assembly into a format corresponding to the configuration of the serial bus; and
providing at an output the information received.

7. The method as claimed in claim 1, wherein step (a) comprises:
inserting image data to be transmitted into a serial data bus format; and
providing the image data to be transmitted at a serial interface of the host computer.

8. The method as claimed in claim 7, comprising:
generating the image data by means of an application.

9. The method as claimed in claim 1, wherein the serial bus supports USB, RS232, Ethernet or V.24 standards.

10. The method as claimed in claim 1, wherein the image data is configured in bitmaps.

11. The method as claimed in claim 1, wherein providing the image data by the host computer includes compressing the image data, and wherein extracting the image data includes decompressing the image data.

12. An apparatus for operating a display device, the display of which is generated by successively received frames of image data and is continuously renewed, the image data defining one or several pixels, the apparatus comprising:
a serial interface for receiving the image data for a frame from the host computer via a serial bus;
an electronic assembly connected between the host computer and the display device and configured to extract, for each frame, the image data from the data received via the serial bus, to store the extracted image data in an image memory of the electronic assembly, and to display the image data stored under the control of the electronic assembly.

13. The apparatus as claimed in claim 12, wherein the electronic assembly is configured to collect a predetermined quantity of image data in the image memory and to display the image data once the predetermined quantity is achieved.

14. The apparatus as claimed in claim 12, wherein the display device has a first resolution in the horizontal direction and a second resolution in the vertical direction, and wherein the image memory comprises a plurality of line sections, the size of the line sections corresponding to the horizontal resolution of the display device, the number of the line sections corresponding to the vertical resolution of the display device.

15. The apparatus as claimed in claim 14, wherein the image memory includes a first memory section and a second memory section, the first/second memory section being configured to receive pixel data, while the second/first memory section provides pixel data for display.

16. The apparatus as claimed in claim 12, wherein the display device has a touch screen associated therewith.

17. The apparatus as claimed in claim 12, wherein the serial bus supports the USB, RS232, Ethernet or V.24 standards.

18. The apparatus as claimed in claim 12, wherein the pixel data is arranged in bitmaps.

19. The apparatus as claimed in claim 12, wherein the image data is compressed image data, and wherein the electronic assembly is configured to decompress the image data.
